(19) United States
(12) Patent Application Publication
(10) Pub. No.: US 2024/0058811 A1
(43) Pub. Date: Feb. 22, 2024

(54) PROCESSING CARTRIDGE

(71) Applicant: SpinChip Diagnostics AS, Olso (NO)

(72) Inventors: Sebastian STENMARK, Olso (NO); Stig Morten BORCH, Oslo (NO); Torgeir HAMSUND, Oslo (NO); Erik L. MEYER, Eiksmarka (NO); Rolf JAHREN, Oslo (NO); Håvard KRISTIANSEN, Oslo (NO); Odd Martin STAAL, Oslo (NO); Steven HILL, Oslo (NO); Didrik PAUS, Oslo (NO); Ole-Andreas KAVLI, Oslo (NO)

(73) Assignee: SpinChip Diagnostics AS, Oslo (NO)

(21) Appl. No.: 18/266,912

(22) PCT Filed: Nov. 30, 2021
(86) PCT No.: PCT/EP2021/083512

§ 371 Date: Jun. 13, 2023

(30) Foreign Application Priority Data
Dec. 21, 2020 (NO) 20201413

(51) Int. Cl. B01L 3/00

(52) U.S. Cl. CPC B01L 3/502707; B01L 2300/043; B01L 2300/047; B01L 2300/0672

(57) ABSTRACT

Disclosed are processing cartridges with main cartridge section and actuating cartridge section, the main cartridge section has liquid reservoir chamber, liquid container, container piercing element and resilient container holding element, the actuating cartridge section can dock with the main cartridge section and comprises actuating member that interacts with the liquid container during docking; the liquid container, piercing element and container holding element are arranged in the liquid reservoir chamber, the liquid container is filled with suitable processing liquid and features pierceable dispensing side, and container piercing element faces the dispensing side; the liquid container is held in a position by the container holding element, dispensing side is separated from the container piercing element; and the actuating member can move the liquid container from the position to another position during docking of cartridge actuating section, and in the other position the dispensing side is pierced by container piercing element.

### CROSS-REFERENCE TO RELATED APPLICATIONS

This application is a U.S. national stage application under 35 U.S.C. § 371 of International Application No. PCT/EP2021/083512, filed Nov. 30, 2021, which claims the priority of Norwegian Application No. 20201413, filed Dec. 21, 2020, the entire contents of each priority application is incorporated herein by reference.

### TECHNICAL FIELD

The present invention relates to the field of processing cartridges, more specifically to a processing cartridge for analysis of a sample and an assembly for providing a sample and releasing a processing liquid into the processing cartridge.

### BACKGROUND

Centrifugation as a mean for accelerating sedimentation of cells, particles and precipitates as well as for separation of liquids or cells with different density has long been an integral part of chemical and biochemical protocols. In addition, the use of centrifugation for running chemical reactions and assays in microfluidic circuits arranged in processing cartridges or chips is a well-known technique, see e.g. Tang et al. “A review of biomedical centrifugal microfluidic platforms”, Micromachines 2016, 7, 26.

In most analytical systems using processing cartridges, the direction of the centrifugal force applied to the microfluidic circuit is constant, and centrifuges similar to a compact disc (CD) player, wherein the microfluidic circuit is arranged in a CD-shaped chip or cartridge, are often used. Typical centrifuges for such analytical systems are disclosed in for instance JP 2018-163169 A and US 2018/0003732 A1.

Other analytical systems make use of dual axis centrifuges able to provide a variable centrifugal force as disclosed in for instance U.S. Pat. No. 4,814,282, WO 2011/081531 A1 and WO 2019/091650 A1. A dual axis centrifuge may provide more flexible and faster means of performing processing in a microfluidic circuit.

A common operational feature in processing cartridges is the introduction of a sample to the microfluidic circuit in a reproducible and secure manner. Further, a processing liquid is often required to dissolve, dilute, wash and/or transfer the sample and/or various reactants within the microfluidic circuit of the processing cartridge.

EP 2881743 A1 discloses a processing cartridge wherein a sample is introduced to the cartridge via an insertion type sample cartridge. The sample cartridge features a member which moves a liquid container in the processing cartridge during insertion. The movement releases the liquid in the liquid container simultaneously with the introduction of the sample.

US 2011/0117665 A1 discloses a processing cartridge featuring a pivotably connected arm for keeping a liquid container within the cartridge immobile before use. The arm is pivoted away from the remaining part of the cartridge during use to provide access to a sample collector and release the liquid container. After sampling, the arm is pivoted back towards the cartridge while simultaneously pushing the liquid container towards a spike to release liquid.

It is an object of the present invention to provide a processing cartridge in which a processing liquid may be stored and released in an improved manner A further object of the invention is a processing cartridge providing improved sampling and handling during use.

### SUMMARY OF THE INVENTION

The present invention is defined by the appended claims and in the following:

In a first aspect, the present invention provides a processing cartridge comprising a main cartridge section and an actuating cartridge section, the main cartridge section comprises a liquid reservoir chamber, a liquid container, a container piercing element and a resilient container holding element, wherein
the actuating cartridge section is configured to dock with the main cartridge section and comprises an actuating member configured to interact with the liquid container during docking;
the liquid container, the piercing element and the container holding element are arranged in the liquid reservoir chamber, the liquid container is filled with a suitable processing liquid and features a pierceable dispensing side, and the container piercing element faces the dispensing side;
the liquid container is held in a first position by the container holding element, wherein the dispensing side is separated from the container piercing element; and
the actuating member is configured to move the liquid container from the first position to a second position during docking of the cartridge actuating section, and in the second position the dispensing side is pierced by the container piercing element.

The dispensing side may comprise any suitable pierceable and fluid tight material, such as an aluminium and/or plastic foil. The dispensing side may also be termed a pierceable sealing cover or pierceable sealing foil.

In other words, the dispensing side faces the container piercing element.

The actuating member may be configured to move the liquid container by direct or indirect interaction with the liquid container. The movement of the liquid container will overcome the force from the resilient container holding element. During the movement of the liquid container, the dispensing side is pushed towards the container piercing element, such that the processing fluid may be released into the liquid reservoir chamber.

In an embodiment of the processing cartridge, the actuating cartridge section may comprise a first end pivotably connected to the main cartridge section, such that the actuating cartridge section may pivot between a non-docking position, in which the liquid container is held in the first position by the container holding element, and a docked position, in which the actuating cartridge section is docked with the main cartridge section and the liquid container is in the second position.

The container holding element may comprise any suitable resilient element able to hold the liquid container in the first position and allow the actuating member to move the liquid container into the second position. The container holding element may be configured to provide an elastic force acting on and holding the liquid container in the first position. Movement of the liquid container from the first position must overcome the elastic force acting on the liquid container. The container holding element may be configured to deflect away from the liquid container during movement of the liquid container towards the second position.

The container holding element may comprise at least one resilient arm in contact with the liquid container. The resilient arm may also be termed a resilient lever.

The resilient arm or lever may be arranged in contact with an edge of the liquid container and arranged to be deflected away from the edge when the actuating member moves the liquid container to the second position. A section of the arm/lever being in contact with the edge of the liquid container may be inclined relative to a direction in which the liquid container is moved by the actuating member. The inclined surface provides a smooth and even movement of the liquid container. The resilient arm/lever may comprise a bend having a first and second opposing sides, wherein the first side is in contact with the liquid container and is pushed towards the second side when the liquid container is moved towards the second position.

In an embodiment of the processing cartridge, the actuating member is configured to enter the liquid reservoir chamber during docking.

In an embodiment of the processing cartridge, the main cartridge section may comprise a cartridge base and a top covering.

In an embodiment of the processing cartridge, the liquid reservoir chamber comprises a sidewall and a base surface. The sidewall and the base surface may be arranged in the cartridge base. The liquid reservoir chamber may further be defined by a top surface. The top surface may be provided by the top covering.

In an embodiment of the processing cartridge, the liquid container may comprise a recess. The actuating member may be configured to interact with an edge of the recess when entering the liquid reservoir chamber during docking. The recess may comprise an edge, by which the actuating member may push or move the liquid container towards the container piercing element, and at least one side surface that may interact with the actuating member to restrict lateral movement of the liquid container. The lateral movement being restricted may be relative to the plane in which the liquid container is pushed or moved, and/or relative to a base surface of the liquid reservoir chamber. The side surface of the recess may be configured such that the actuating member may prevent lateral movement of the liquid container away from the base surface.

The actuating member may be fin-shaped, i.e. be an actuating fin. A portion of the actuating member interacting with the liquid container may have a rounded periphery to obtain a smooth and even interaction with an edge of the recess.

Having the actuating member interacting with a recess in the liquid container provides a stable movement of the liquid container towards the piercing element and prevents lateral movement of the liquid container relative to the actuating member.

In an embodiment, the processing cartridge may comprise a sample collector, the sample collector arranged to be accessible for collection of a sample when the actuating cartridge section is separated from the main cartridge section or is in the non-docking position.

The sample collector may be any element suitable for retrieving a solid, semi-solid, mucous or liquid sample from a subject or object. The sample collector may be a capillary tube for collecting a liquid sample such as whole blood or a swab for collecting a semi-solid/mucous sample.

In an embodiment of the processing cartridge, the sample collector may be arranged on the actuating cartridge section, such that the sample collector is accommodated in a sample receiving cavity in the main cartridge section when the actuating cartridge section is docked with the main cartridge section or is in the docked position.

The actuating cartridge section may be a longitudinal section.

In an embodiment of the processing cartridge, the actuating cartridge section may comprise a second end at which the sample collector is arranged.

In an embodiment of the processing cartridge, the main cartridge section may feature at least one guide rib or recess configured to interact with a corresponding at least one recess or guide rib, respectively, in the actuating cartridge section during docking. The guide rib may feature a tapered edge for insertion into the recess.

The guide rib/recess may be arranged at a peripheral section of the main cartridge section and the corresponding recess/guide rib may be arranged at a side of the actuating cartridge section facing the main cartridge section during docking.

In an embodiment of the processing cartridge, the main cartridge section or the actuating cartridge section may feature a locking rib, having locking recesses arranged on opposite sides thereof, and the corresponding actuating cartridge section or main cartridge section, may feature two opposing resilient hooks, each hook is configured for interaction with a respective locking recess on the locking rib, wherein the locking rib has a tapered edge configured to be inserted between the resilient hooks during docking.

The solution of having two opposing hooks between which the locking rib is inserted allows for a smaller deflection of the hooks, relative to the use of a single hook providing an equally secure locking. The smaller deflection ensures a more even and smooth locking motion. However, in an alternative embodiment, the locking rib may feature a single recess for interaction with a single hook, the single recess may for instance be arranged at an end of the locking rib.

In an embodiment of the processing cartridge, the container piercing element may comprise a base portion, at least one side portion and a sharp portion distal to the base portion. The sharp portion, e.g. a spike, may be arranged towards the dispensing side of the liquid container.

In an embodiment of the processing cartridge, the container piercing element may comprise at least one recess arranged in the side portion. The recess may extend between the base portion and the sharp portion.

In an embodiment of the processing cartridge, the container piercing element and the container holder element constitute parts of a single unit.

In an embodiment of the processing cartridge, the liquid reservoir chamber comprises a sidewall and a base surface featuring a knob, and the single unit is secured within the liquid reservoir chamber by having a section of the single unit arranged between the knob and the sidewall.

In an embodiment of the processing cartridge, the actuating cartridge section may be connected to the main cartridge section by a pivot connection, wherein
the actuating cartridge section or the main cartridge section features a first end comprising two opposing pinch arms and a resilient arm arranged between the pinch arms, each of the pinch arms features a pivot knob and the pivot knobs are arranged opposite each other (i.e. faces each other); and
the corresponding main cartridge section or actuating cartridge section features a connector hub for insertion between the two pinch arms, the connector hub comprises a bore for accommodating the pivot knobs and has an outer periphery for interaction with the resilient arm;
wherein a first section of the outer periphery has a shorter distance to a centreline of the bore than a second section of the outer periphery, the first and second section of the outer periphery are connected by a third section of the outer periphery having an increasing distance to the centreline of the bore, the third section of the periphery arranged such that movement of the actuating cartridge section will face a defined resistance when the resilient arm interacts with the third section.

In other words, movement of the actuating cartridge section will face a defined resistance when a pivot movement of the actuating cartridge section causes the resilient arm to interact with the third section. The defined resistance may be an even, variable or controllable resistance.

In other words, the third section of the outer periphery has a distance to the centreline of the bore which increases from a distance being equal to the distance of the first section to the distance of the second section.

The bore may have an inner circular periphery arranged to accommodate the pivot knobs. The pivot knobs have an outer periphery of which at least two opposing sections cooperate with the inner circular periphery of the bore. The two opposing sections may be radial or curved sections. When accommodated in the bore, a centreline being common for both pivot knobs coincides with the centreline of the bore. The opposing sections may ensure that the centreline common for both pivot knobs coincides with the centreline of the bore.

In an embodiment of the processing cartridge, the actuating cartridge section may be connected to the main cartridge section by a pivot connection, wherein
the actuating cartridge section or the main cartridge section features a first end comprising two opposing pinch arms, each of the pinch arms features a pivot knob and the pivot knobs are arranged opposite each other; and
the corresponding main cartridge section or actuating cartridge section features a connector hub for insertion between the two pinch arms, the connector hub comprises a bore for accommodating the pivot knobs, the bore is defined by a middle section having a circular inner wall, and a first section and a second section arranged on opposite sides of the middle section, each of the first and second section comprises a recess extending between the bore and an outer periphery of the connector hub;
each of the pivot knobs has an outer periphery comprising two opposing first sections configured to cooperate with the circular inner wall and two opposing second sections, wherein a distance between the second sections is shorter than a maximum distance between the first sections, and each recess has a width being smaller than the maximum distance between the first sections and larger than a maximum distance between the second sections.

The pivot knobs and the recess are dimensioned and configured such that the connector hub may be inserted between the pinch arms, with a minimum deflection of the pinch arms, when each of the pivot knobs are oriented with one of the first sections facing the respective recess.

The first sections may be radial or curved sections, and the second sections may be parallel straight sections.

In an embodiment of the processing cartridge, the main cartridge section may comprise a microfluidic circuit, the microfluidic circuit may be connected to the sample receiving cavity and the liquid reservoir chamber.

In an embodiment of the processing cartridge, the main cartridge section and the actuating cartridge section may define a disc-shaped body when the actuating cartridge section is in the docked position.

In a second aspect, the present invention provides a processing cartridge comprising a main cartridge section and an actuating cartridge section, the main cartridge section comprises a liquid reservoir chamber, a liquid container and a container piercing element, wherein
the actuating cartridge section is configured to dock with the main cartridge section and comprises an actuating member configured to interact with the liquid container during docking;
the liquid container and the piercing element are arranged in the liquid reservoir chamber, the liquid container is filled with a suitable processing liquid and features a pierceable dispensing side, and the container piercing element faces the dispensing side;
the liquid container is in a first position before docking, wherein the dispensing side is separated from the container piercing element; and
the actuating member is configured to move the liquid container from the first position to a second position during docking of the cartridge actuating section, and in the second position the dispensing side is pierced by the container piercing element.

The second aspect of the invention may comprise any of the features of the embodiments of the first aspect.

In a third aspect, the present invention provides a processing cartridge comprising a main cartridge section and an actuating cartridge section, the main cartridge section comprises a liquid reservoir chamber, a liquid container, a container holding element and a container piercing element, wherein
the actuating cartridge section is configured to dock with the main cartridge section and comprises an actuating member configured to interact with the liquid container during docking;
the liquid container and the piercing element are arranged in the liquid reservoir chamber, the liquid container is filled with a suitable processing liquid and features a pierceable dispensing side, and the container piercing element faces the dispensing side;
the liquid container is held in a first position by the container holding element, wherein the dispensing side is separated from the container piercing element; and
the actuating member is configured to move the liquid container from the first position to a second position during docking of the cartridge actuating section, and in the second position the dispensing side is pierced by the container piercing element.

The third aspect of the invention may comprise any of the features of the embodiments of the first aspect.

The actuating member of the first, second and third aspect may be configured to move the liquid container by direct or indirect interaction with the liquid container.

In a fourth aspect, the present invention provides a method of introducing a sample to a processing cartridge, the processing cartridge comprises a main cartridge section, an actuating cartridge section and a sample collector, the main cartridge section comprises a liquid reservoir chamber, a liquid container, a container piercing element and a resilient container holding element, wherein
the actuating cartridge section is configured to dock with the main cartridge section and comprises a first end and an actuating member, the first end is pivotably connected to the main cartridge section and the actuating member is configured to interact with the liquid container during docking;
the liquid container and the piercing element are arranged in the liquid reservoir chamber, the liquid container is filled with a suitable processing liquid and features a pierceable dispensing side, and the container piercing element faces the dispensing side;
the actuating cartridge section may be arranged in a non-docking position in which the liquid container is held in a first position by the container holding element, in the first position the dispensing side is separated from the container piercing element and the sample collector is available for collection of a sample; and the method comprises the steps of:
   holding the actuating cartridge section in the non-docking position;
   collecting a sample with the sample collector; and
   pivoting the actuating cartridge section to a docked position, in which the actuating member has moved the liquid container from the first position to a second position wherein the dispensing side is pierced by the container piercing element.

In an embodiment of the method, the main cartridge section comprises a sample cavity, and the sample collector is introduced into the sample cavity when the actuating cartridge section is pivoted to the docked position.

In an embodiment of the processing cartridge, an internal volume of the main cartridge section comprises a microfluidic circuit for processing of a sample, e.g. for analysing the sample.

The term “processing cartridge” is intended to mean a chip/cartridge comprising an internal fluid circuit suitable for performing analysis, assays etc. on a suitable sample introduced into the cartridge, as well as performing various types of chemical reactions, such as polymerase chain reaction (PCR) and synthetic chemistry reactions.

### DESCRIPTION OF THE DRAWINGS

Embodiments of the invention will now be described in greater detail by way of example only and with reference to the following drawings:

FIG. 1 is a perspective view of an exemplary processing cartridge according to the invention.

FIG. 2 is a perspective view of the processing cartridge in FIG. 1, wherein a top foil is removed.

FIG. 3 is an exploded view of the processing cartridge in FIG. 1.

FIG. 4 is a perspective side view of the processing cartridge in FIG. 1, wherein a sampler arm is in a non-docking position.

FIG. 5 is a perspective side view of the processing cartridge in FIG. 1, wherein a sampler arm is in a docked position.

FIGS. 6a-6c are detailed side views of the processing cartridge in FIG. 1.

FIG. 7 is a side view of the of the processing cartridge in FIG. 1.

FIG. 8 is a sectional view of the processing cartridge in FIG. 7.

FIG. 9 shows perspective views of unit featuring a spike and a resilient arm for use in a processing cartridge according to the invention.

FIG. 10 shows a perspective view and an exploded view of a liquid container for use in a processing cartridge according to the invention.

FIG. 11 is a perspective view of a sampler arm for use in a processing cartridge according to the invention.

FIG. 12. is a perspective side view of the processing cartridge in FIG. 1 without a sampler arm.

FIG. 13 show details of a pivot coupling for a processing cartridge according to the invention.

FIGS. 14 and 15 show details of the pivot coupling in FIG. 13.

FIGS. 16a-16c show details of the pivot coupling in FIG. 13.

FIGS. 17a-17b show details of a locking mechanism for a processing cartridge according to the invention.

### DETAILED DESCRIPTION OF THE INVENTION

The object of the present invention is to provide a processing cartridge suitable for use in centrifuge-based analytical system as described in the background section.

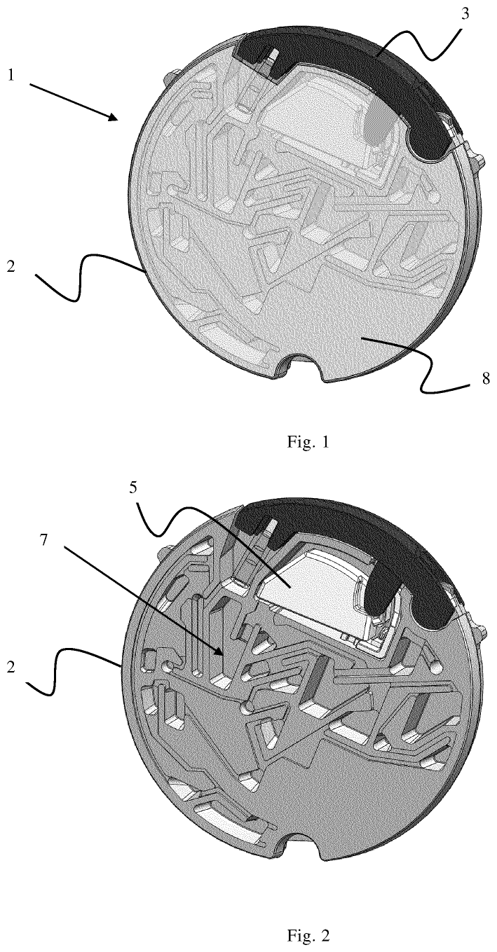

An exemplary processing cartridge according to the invention is shown in FIGS. 1 and 2.

The processing cartridge 1 comprises a main cartridge section 2 and a sampler arm 3 (i.e. an actuating cartridge section).

The main cartridge section 2 features an internal fluidic or microfluidic circuit 7. An exemplary fluidic circuit 7 is shown in the cartridges of FIGS. 1-3 for illustrative purposes. The fluidic circuit of the processing cartridge may be designed for processing a sample, for instance performing various types of analytical assays on a whole blood sample, or for processing various chemical reactions including polymerase chain reaction (PCR) and synthetic chemistry reactions. The processing cartridge may for instance include micro channels and a variety of cavities for handling, processing and transporting nL-quantities, μL-quantities and mL-quantities of various liquids. Further, the cartridge may be optically transparent or translucent. This allows studying of transportation of liquids, colour development, separations, etc. throughout the cartridge. The sample may be fluidic, semi-solid or solid, typically a whole blood, plasma, serum, urine, mucous, tissue or stool sample. Semi-solid and solid samples are fluidized before processing in the fluidic circuit. Also, the cartridge may contain one or more reagents. Exemplary fluidic circuits that may be used in a processing cartridge according to the present invention is disclosed in for instance WO 2011/081530 A1, the content of which is incorporated herein by reference. Further, various methods that may be performed in such fluid circuits, as well as suitable fluid circuits, are disclosed in PCT/EP2015/063811, PCT/EP2015/063817 and PCT/EP2015/063824.

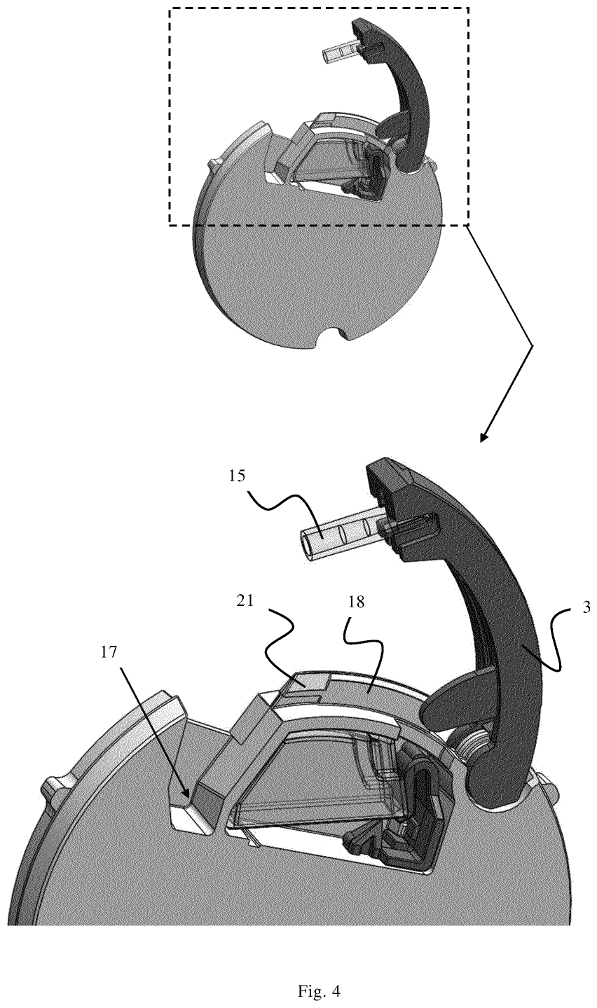

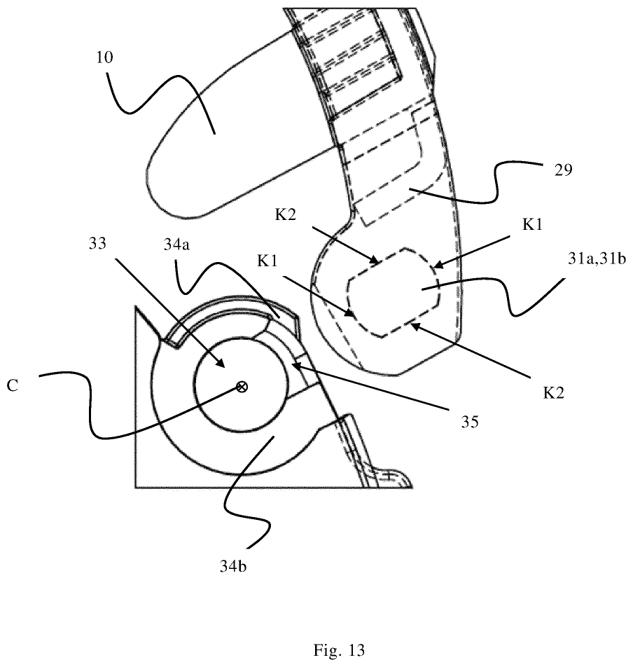

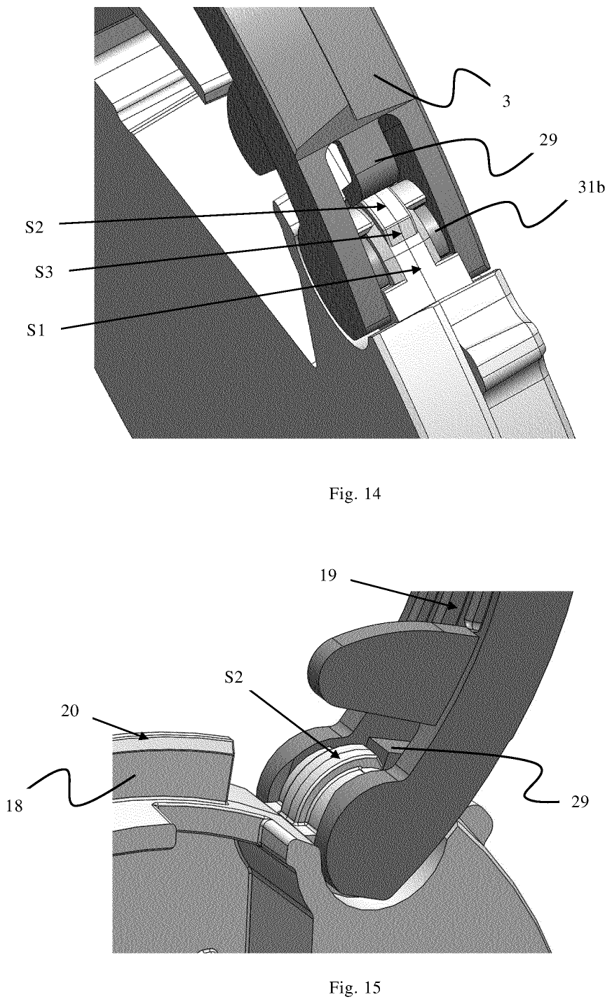

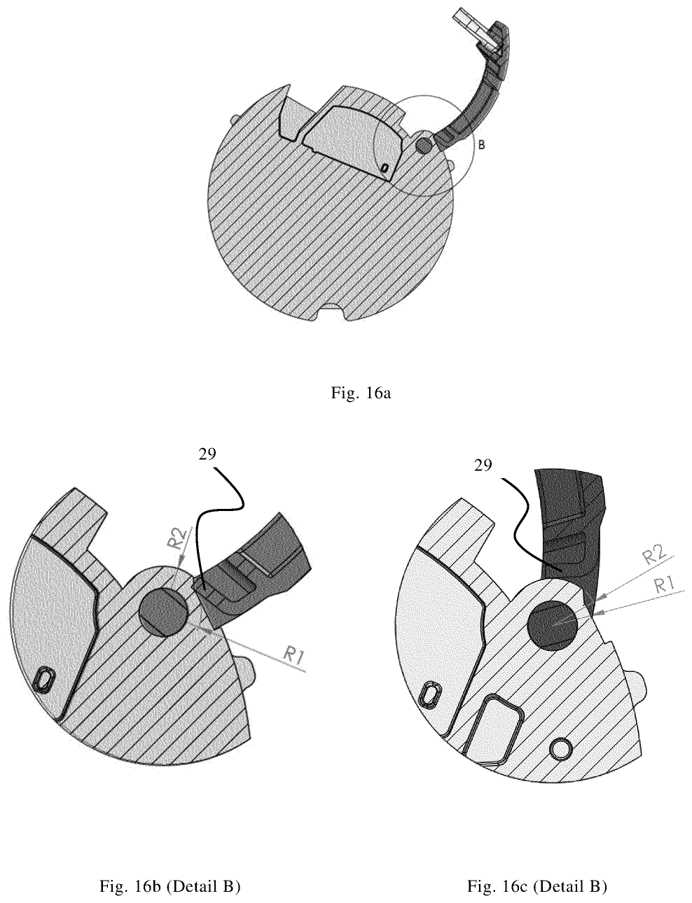

In FIG. 1, the main cartridge section 2 comprises a cartridge base 2a and a top covering 2b that closes off one side of the fluidic circuit 7 in the cartridge base 2a. The top covering 2b may for instance be a layer of rigid plastic film. For sake of clarity, the fluidic circuit 7 and the top covering 2b are left out in the remaining FIGS. 4-17.

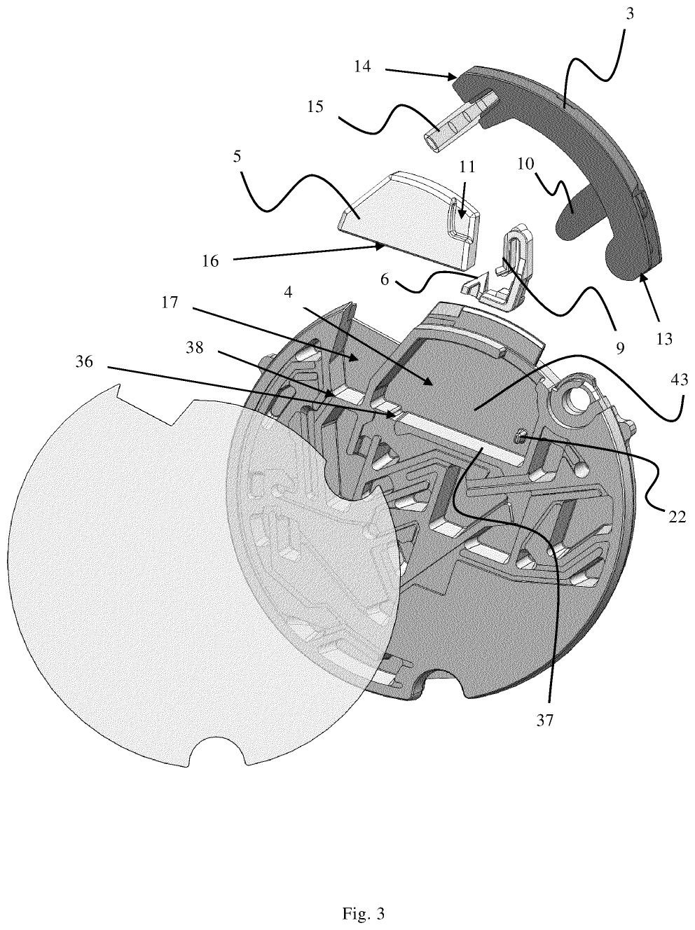

An exploded view of the processing cartridge 1 is shown in FIG. 3 to illustrate the main parts making up the processing cartridge. The function of the processing cartridge and its various advantageous features are described by reference to FIGS. 4-17.

As described above, the processing cartridge is made up of a main cartridge section 2 and a sampler arm 3.

The main cartridge section 2 features a liquid reservoir chamber 4, a liquid container 5, a spike 6 (i.e. a container piercing element) and a resilient arm 9 (i.e. a resilient container holding element).

The sampler arm 3 has a first end 13 pivotably connected to the main cartridge section. A second end 14 of the sampler arm 3 features a capillary tube 15 (i.e. a sample collector) for collection of a sample. The sampler arm 3 is configured to dock with the main cartridge section 2. An actuating fin 10 (i.e. an actuating member) is arranged on the sampler arm 3 and is configured to enter the liquid reservoir chamber 4 during docking of the sampler arm 3 with the main cartridge section 2.

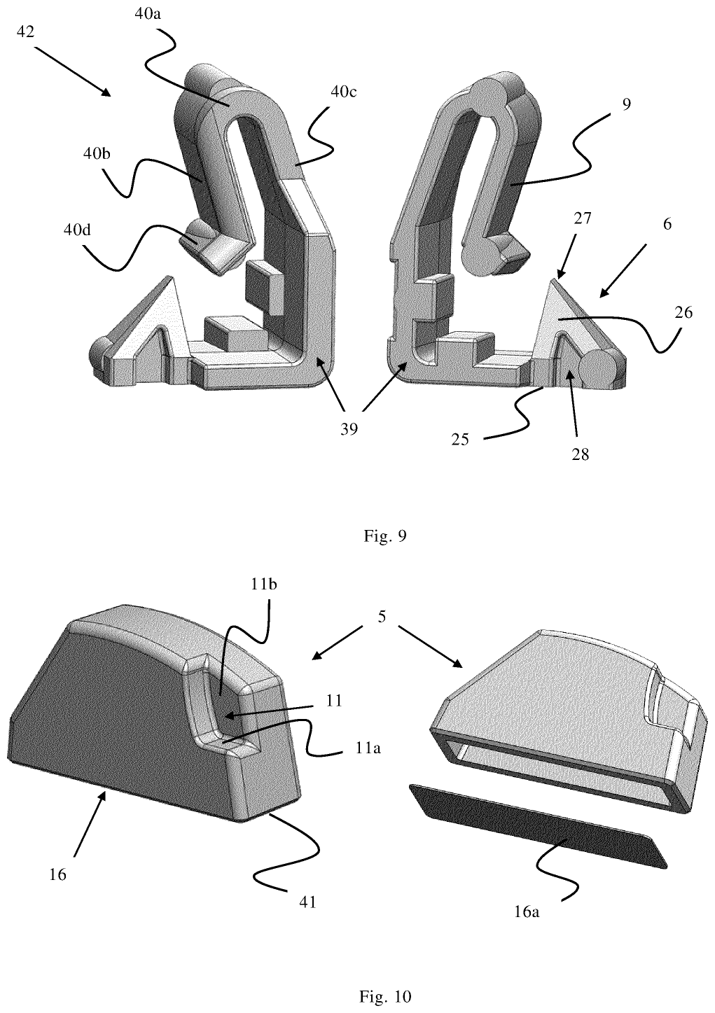

The liquid container 5, the spike 6 and the resilient arm 9 are arranged in the liquid reservoir chamber 4. The liquid container 5 is filled with a suitable processing liquid and features a pierceable dispensing side 16, see FIG. 10. The processing liquid may for instance be any suitable buffer and/solvent depending on the type of analysis to be performed and/or type of sample to be analysed. The dispensing side 16 features at least a section comprising a pierceable and liquid tight foil 16a. The liquid tight foil 16a may for instance be made of aluminium, a suitable polymer material or any combination thereof.

The spike 6 is arranged to face the dispensing side of the liquid container 5. In this embodiment, see FIG. 9, the spike 6 comprises a base portion 25, a side portion 26 and a sharp portion 27 distal to the base portion. The side portion 26 may feature a recess 28 extending between the base portion 25 and the sharp portion 27. When the dispensing side is pierced by the spike 6, an aluminium or polymer foil of the dispensing side may in some cases seal against the spike such that a liquid is not released as freely as desired. In such cases, the recess 28 will provide a more reproducible release of liquid by disrupting potential sealing of the foil against the side portion 26.

To obtain a simple way to fasten the spike 6 and the resilient arm 9 within the liquid reservoir chamber 4, the spike 6 and the resilient arm 9 are interconnected by a connecting section 39, i.e. they form parts of a single element or unit, see FIG. 9. The liquid reservoir chamber 4 features a sidewall 37 and a base surface 43 having a knob 22, see e.g. FIG. 3. The spike 6 and the resilient arm 9 is secured within the liquid reservoir chamber 4 by having the connecting section 39 arranged between the knob 22 and the sidewall 37.

During use, the sampler arm is initially arranged in a non-docking position as shown in FIGS. 4, 15 and 16. In the non-docking position, the liquid container 5 is held in a first position by the resilient arm 9 such that the dispensing side 16 is separated from the spike 6. The capillary tube 15 is accessible for collection of a sample when the sampler arm is in the non-docking position. The sample may for instance be a whole blood sample from a patient. In this manner, a sample may be collected while the liquid container is secured and prevented from moving towards the spike. Due to the biasing force of the resilient arm 9, the liquid container is held in place even if the processing cartridge is subjected to sharp movements during the sample collection. The latter effect is highly advantageous as premature release of even minor amounts of liquid may have an impact on a subsequent sample analysis. Thus, the secure positioning of the liquid container during sampling removes a possible cause of error in the analytical results.

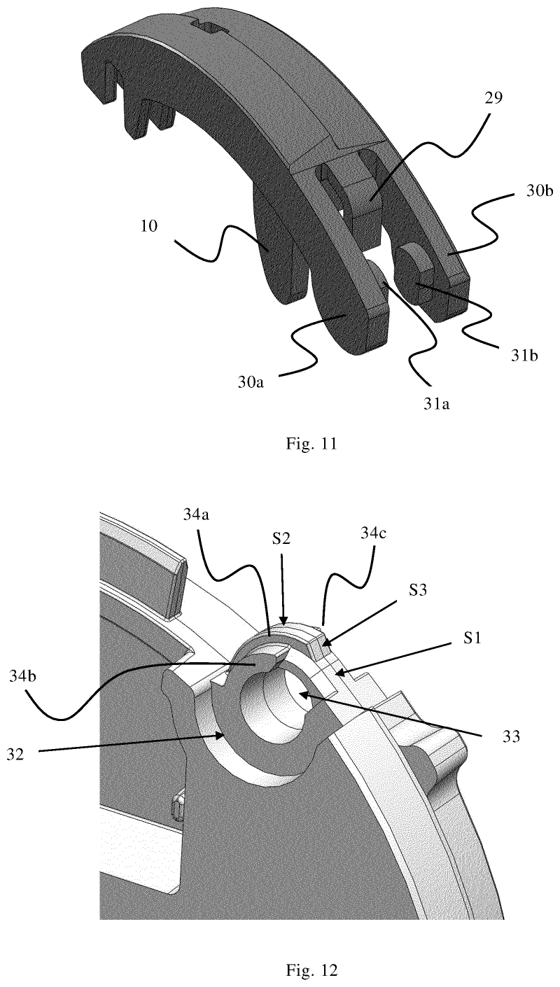

To avoid unintended movement of the sampler arm relative to the main cartridge section during sampling, the sampler arm is connected to the main cartridge section by a pivot coupling providing resistance against movement of the sampler arm from the non-docking position. The pivot coupling is obtained by having two opposing pinch arms 30a,30b at the first end 13 of the sampler arm 3 and a resilient arm 29 arranged between the pinch arms 30a,30b, see FIGS. 11-16. Each of the pinch arms featuring a pivot knob 31a,31b and the pivot knobs are arranged opposite each other. The main cartridge section 2 features a connector hub 32 for insertion between the two pinch arms 30a,30b of the sampler arm 3. The connector hub 32 comprises a bore 33 for accommodating the pivot knobs 31a,31b and has an outer periphery for interaction with the resilient arm 29. A first section S1 of the outer periphery has a shorter distance R1 to a centreline C of the bore 33 than a second section S2 of the outer periphery. The first and second section are interconnected by a third section S3 of the outer periphery having an increasing distance, i.e. from R1 to R2, to the centreline C of the bore.

During movement of the sampler arm from the non-docked position, the resilient arm 29 will exert a defined resistance against the movement when interacting with the third section of the outer periphery.

To increase the lateral stiffness of the pivot coupling, the bore 33 is defined by a middle section 34a having a circular inner wall, and a first section 34b and a second section 34c arranged on opposite sides of the middle section. Each of the first and second sections comprises a recess 35 extending between the bore 33 and an outer periphery of the connector hub 32. Each pivot knob 31a,31b has an outer periphery comprising two opposing radial sections K1 configured to cooperate with the circular inner wall and two opposing parallel sections K2, wherein a distance between the parallel sections K2 is shorter than a maximum distance between the radial sections K1, and each recess 35 has a width being smaller than the maximum distance between the radial sections K1 and larger than a maximum distance between the parallel sections K2. The dimensions of the pivot knobs 31a,31b and the recesses 35 are configured such that the connector hub 32 may be inserted between the pinch arms 30a,30b by a minimum deflection of the pinch arms, when each of the pivot knobs 31a,31b is oriented with one of the radial sections K1 facing the respective recess 35. Due to the minimal deflection of the pinch arms during connection to the connector hub 32 via the recesses 35, the stiffness of the pinch arms may be increased, and the lateral stiffness of the pivot coupling is optimized.

In other embodiments, the main cartridge section may feature two opposing pinch arms as described above, while a connector hub as described above is arranged on the first end of the sampler arm.

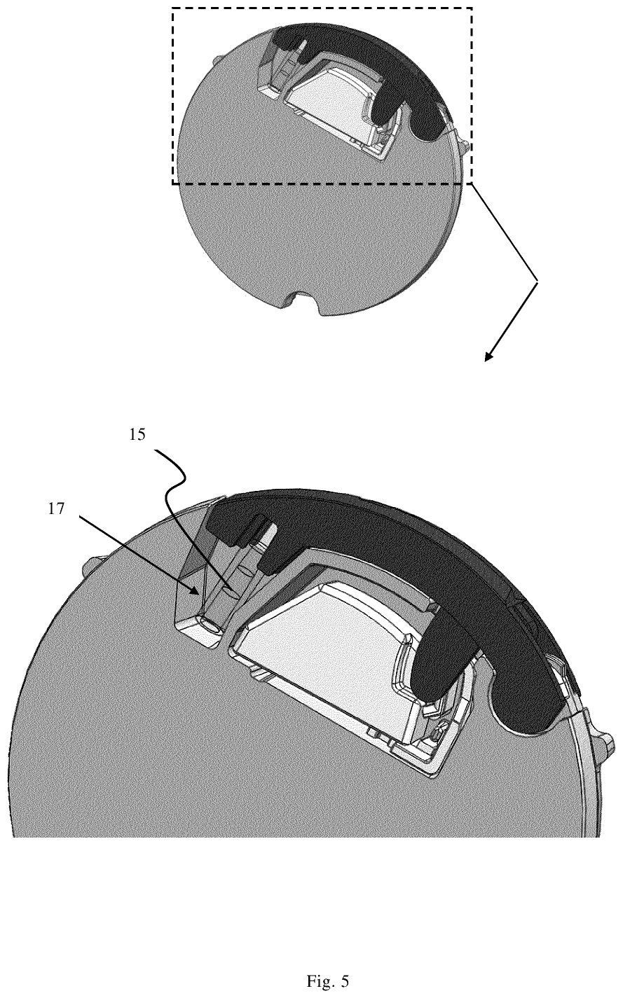

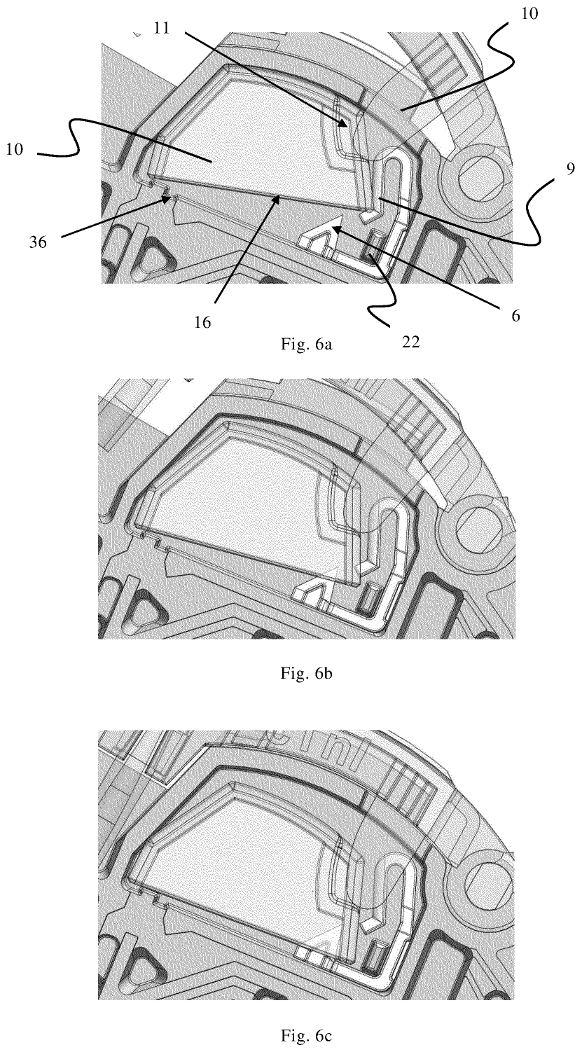

After a sample has been collected by the capillary tube 15, the sampler arm is pivoted from the non-docking position to a docked position, see FIGS. 5 and 6c, and the capillary tube 15 is introduced into the sample cavity 17. The sample cavity 17 comprises a sample inlet 38 connected to a fluidic circuit 7 of the main cartridge section.

When the sampler arm 3 is in the docked position, the liquid container is in a second position. In the second position, the dispensing side 16 of the liquid container has been pierced and liquid may be released into the liquid reservoir chamber 4. The liquid reservoir chamber 4 comprises a liquid outlet 36 through which a processing liquid may be transferred after being released from the liquid container.

During the movement towards the docked position, see FIGS. 6b and 7, the actuating fin 10 enters the liquid reservoir chamber 4 and into contact with the liquid container 5. In the illustrated embodiment, the actuating fin 10 interacts with an edge 11a of a recess 11 arranged in a side of the liquid container 5, see FIG. 10. By interacting with the recess 11, instead of e.g. a top section of the liquid container, the actuating fin 10 helps to guide and stabilise the movement of the liquid container towards the spike 6. Thus, minor lateral movements of the liquid container 5 relative to its directional movement towards the spike 6 is avoided or restricted. Such lateral movements may otherwise prevent a smooth and even movement of the liquid container 5, may cause the liquid container to be stuck, or cause an insufficient or too extensive piercing of the dispensing side. A further important advantage of restricting the lateral movement of the liquid container 5 is that the liquid container 5 is prevented from being pushed against the top covering 2b during its movement from the first position to the second position. The top covering 2b is laminated to the cartridge base 2a, e.g. by heat or a suitable glue. The lamination between the top covering 2b and the cartridge base 2a may have weak spots at the top of the walls in the cartridge base 2a forming the fluidic circuit 7. Thus, by preventing the liquid container 5 from being pushed against the top covering 2b, accidental delamination of the top covering 2b from parts of the cartridge base 2a is avoided. Alternative designs of suitable recesses are envisioned, and all comprises an edge 11a, by which the actuating fin 10 may push or move the liquid container 5 towards the spike 6, and at least one side surface 11b which interacts with the actuating fin 10 to restrict lateral movement. The side surface 11b configured such that the actuating fin may prevent lateral movement of the liquid container away from the base surface 43.

The resilient arm 9 is configured to be deflected away from an edge of the liquid container, when the liquid container 5 is moved towards the spike 6. The deflection may result in an elastic and/or plastic deformation, or even breaking, of the resilient arm. In the exemplary processing cartridge, the resilient arm features a bend 40a and a first 40b and a second 40c opposing sides, wherein the first side 40b is in contact with the liquid container 5 and is pushed towards the second side 40c when the liquid container 5 is moved towards the second position, see FIG. 9. The first side 40b has an inclined portion 40d in contact with an edge 41 of the dispensing side of the liquid container 5.

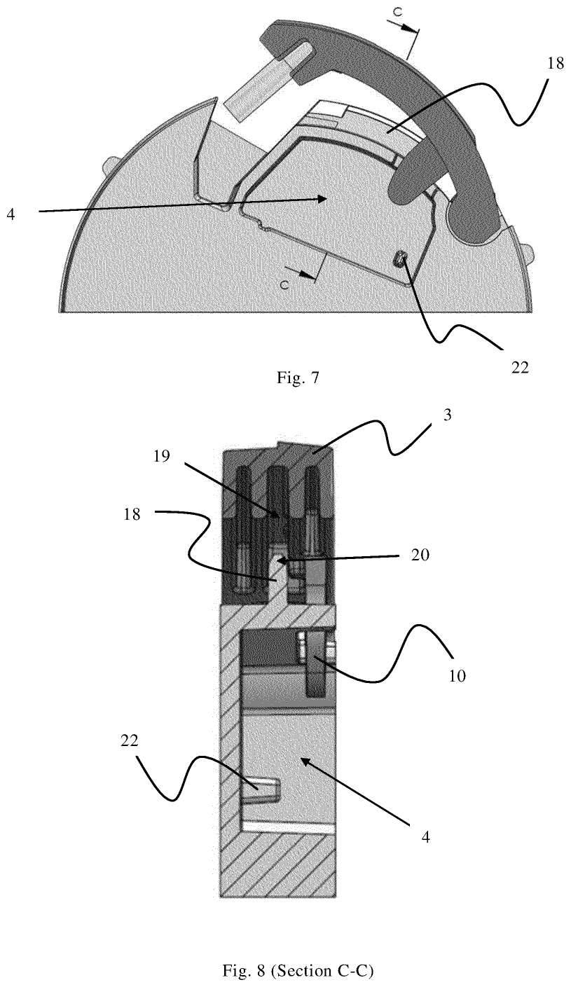

The processing cartridge 1 according to the invention may comprise features for restricting lateral movement of the sampler arm 3 during movement of the sampler arm 3 towards the docked position. That is preventing movement of the sampler arm 3 in a direction perpendicular to the plane of the pivot movement towards the docked position. In this embodiment, the main cartridge section 2 comprises a guide fin 18 and the sampler arm has a guide recess 19 into which the guide fin is introduced during the pivot movement of the sampler arm, see FIGS. 7 and 8. The guide fin 18 has a tapered edge 20 facing the guide recess 19, such that the lateral restriction provided by the interaction between the guide fin and the guide recess may be optimal while ensuring a smooth interaction during the movement of the sampler arm towards the docked position. By restricting or preventing lateral movement of the sampler arm, potential errors in the sampling procedure is minimized Such errors may be caused by sharp movements of the sampler arm which may release some of the sample prematurely, e.g. release of sample before the capillary tube has entered the sample cavity 17. In other embodiments, the sampler arm 3 may comprise a guide fin, while a guide recess is arranged on the main cartridge section 2.

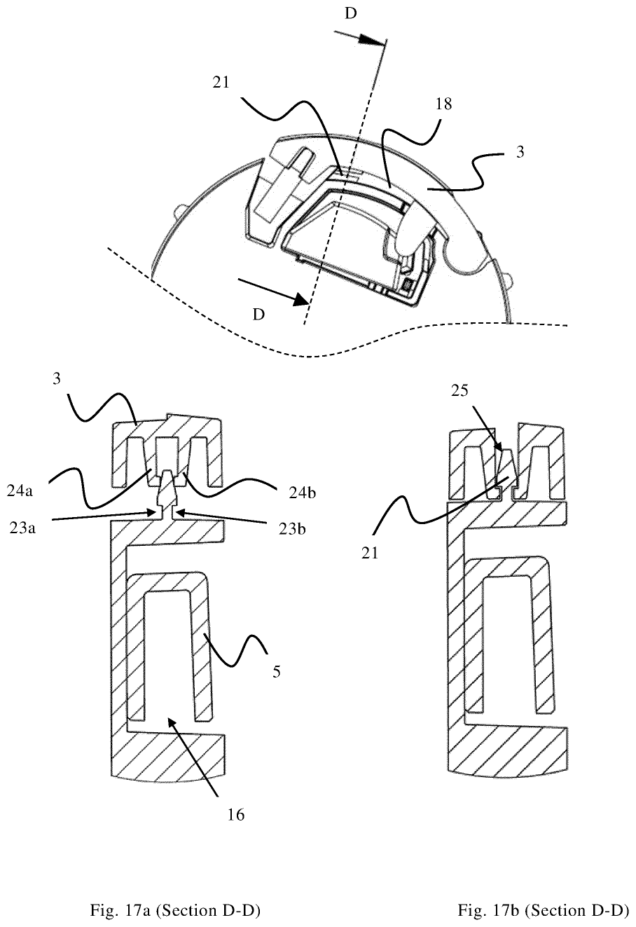

In the docked position, the sampler arm 3 is connected to the main cartridge section 2 by a locking mechanism. In the exemplary processing cartridge, the main cartridge section 2 features a locking rib 21, having locking recesses 23a,23b arranged on opposite sides thereof, see FIGS. 17a and 17b. The locking rib 21 may be a continuation of the guide rib 18. The sampler arm 3 features two opposing resilient hooks 24a,24b, each hook 24 configured for interaction with a respective locking recess 23a,23b on the locking rib. The locking rib 21 has a tapered edge 25 configured to be inserted between the resilient hooks 24 during docking of the sampler arm 3. The solution of having two opposing hooks between which the locking rib is inserted allows for a smaller deflection of the hooks 24a,24b, relative to the deflection of a single hook at one side of the locking rib designed to provide an equally secure locking. The smaller deflection ensures a more even and smooth movement of the sampler arm 3 during locking. The latter effect is advantageous in that sharp movements of the sampler arm is avoided or minimised. Sharp movements may release some of the sample prematurely, e.g. release of sample into the sample cavity 17, or from the top of the capillary tube 15, before the processing cartridge 1 has been introduced in a centrifuge-based analytical system. In other embodiments, the sampler arm 3 may comprise a locking rib, while two opposing resilient hooks are arranged on the main cartridge section 2.

In the exemplary processing cartridge, the liquid container is held in the first position by the resilient arm 9. However, other suitable resilient members are envisioned and may have any form provided the member is able to hold the liquid container in the first position, preferably by an elastic force, and allow the actuating fin to move the liquid container towards the second position against a biasing force. In other embodiments, the resilient arm 9 or any other suitable resilient member may be manufactured (e.g. molded) as an integral part of the liquid container 5 or the liquid reservoir chamber 4.

In the exemplary processing cartridge, the spike 6 is molded separate from the cartridge base 2a. In other embodiments, the spike 6 may be manufactured (e.g. molded) as an integral part of the liquid reservoir chamber 4.

The exemplary processing cartridge illustrated and described herein comprises a combination of several highly advantageous features. However, in other embodiments of the invention, an advantageous processing cartridge may comprise any desired combination of the described features.

In the exemplary embodiment, the circumference of the processing cartridge is substantially circular. However, in other embodiments the circumference of the processing cartridge may have any suitable shape, such as rectangular, square or elliptic.

1. A processing cartridge comprising a main cartridge section and an actuating cartridge section, the main cartridge section comprises a liquid reservoir chamber, a liquid container, a container piercing element and a resilient container holding element, wherein
the actuating cartridge section is configured to dock with the main cartridge section and comprises an actuating member configured to interact with the liquid container during docking;
the liquid container, the piercing element and the container holding element are arranged in the liquid reservoir chamber, the liquid container is filled with a suitable processing liquid and features a pierceable dispensing side, and the container piercing element faces the dispensing side;
the liquid container is held in a first position by the container holding element, wherein the dispensing side is separated from the container piercing element; and
the actuating member is configured to move the liquid container from the first position to a second position during docking of the cartridge actuating section, and in the second position the dispensing side is pierced by the container piercing element.

2. A processing cartridge of claim 1, wherein the actuating cartridge section comprises a first end pivotably connected to the main cartridge section, such that the actuating cartridge section may pivot between a non-docking position, in which the liquid container is held in the first position by the container holding element, and a docked position, in which the actuating cartridge section is docked with the main cartridge section and the liquid container is in the second position.

3. A processing cartridge of claim 1, wherein the container holding element is configured to provide an elastic force acting on and holding the liquid container in the first position.

4. A processing cartridge of claim 1, wherein the container holding element comprises a resilient arm in contact with the liquid container.

5. A processing cartridge of claim 1, wherein the actuating member is configured to enter the liquid reservoir chamber during docking and the liquid container comprises a recess, the actuating member is configured to interact with an edge of the recess when entering the liquid reservoir chamber during docking.

6. A processing cartridge of claim 1, comprising a sample collector, the sample collector arranged to be accessible for collection of a sample when the actuating cartridge section is separated from the main cartridge section or is in the non-docking position.

7. A processing cartridge of claim 6, wherein the sample collector is arranged on the actuating cartridge section, such that the sample collector is accommodated in a sample receiving cavity in the main cartridge section when the actuating cartridge section is docked with the main cartridge section or is in the docked position.

8. A processing cartridge of claim 1, wherein the main cartridge section features at least one guide rib or recess configured to interact with a corresponding recess or guide rib, respectively, in the actuating cartridge section during docking.

9. A processing cartridge of claim 8, wherein the guide rib features a tapered edge for insertion into the recess.

10. A processing cartridge of claim 1, wherein the main cartridge section or the actuating cartridge section features a locking rib having locking recesses arranged on opposite sides thereof, and the corresponding actuating cartridge section or main cartridge section features two opposing resilient hooks, each hook configured for interaction with a respective locking recess on the locking rib, wherein the locking rib has a tapered edge configured to be inserted between the resilient hooks during docking.

11. A processing cartridge of claim 1, wherein the container piercing element comprises a base portion, at least one side portion, a sharp portion distal to the base portion, and at least one recess arranged in the side portion and extending between the base portion and the sharp portion.

12. A processing cartridge of claim 1, wherein the container piercing element and the container holder element constitute parts of a single unit.

13. A processing cartridge of claim 12, wherein the liquid reservoir chamber comprises a sidewall and a base surface featuring a knob, and the single unit is secured within the liquid reservoir chamber by having a section of the single unit arranged between the knob and the sidewall.

14. A processing cartridge of claim 1, wherein the actuating cartridge section is connected to the main cartridge section by a pivot connection, wherein
the actuating cartridge section or the main cartridge section features a first end comprising two opposing pinch arms and a resilient arm arranged between the pinch arms, each of the pinch arms features a pivot knob and the pivot knobs are arranged opposite each other; and
the corresponding main cartridge section or actuating cartridge section features a connector hub for insertion between the two pinch arms, the connector hub comprises a bore for accommodating the pivot knobs and has an outer periphery for interaction with the lever;
wherein a first section (S1) of the periphery has a shorter distance (R2) to a centreline of the bore than a second section (S2) of the periphery, the first and second section of the periphery are connected by a third section (S3) of the periphery having an increasing distance to the centreline (C) of the bore, the third section of the outer periphery arranged such that a rotary movement of the actuating cartridge section relative to the main cartridge section will face a defined resistance when the resilient arm interacts with the third section.

15. A processing cartridge of claim 1, wherein the actuating cartridge section is connected to the main cartridge section by a pivot connection, wherein
the actuating cartridge section or the main cartridge section features a first end comprising two opposing pinch arms, each of the pinch arms features a pivot knob and the pivot knobs are arranged opposite each other; and
the corresponding main cartridge section or actuating cartridge section features a connector hub for insertion between the two pinch arms, the connector hub comprises a bore for accommodating the pivot knobs, the bore is defined by a middle section having a circular inner wall, and a first section and a second section arranged on opposite sides of the middle section, each of the first and second section comprises a recess extending between the bore and an outer periphery of the connector hub;
each of the pivot knobs has an outer periphery comprising two opposing first sections configured to cooperate with the circular inner wall and two opposing second sections, wherein a distance between the second sections is shorter than a maximum distance between the first sections, and each recess has a width being smaller than the maximum distance between the first sections and larger than a maximum distance between the second sections.

16. A method of introducing a sample to a processing cartridge, the processing cartridge comprises a main cartridge section, an actuating cartridge section and a sample collector, the main cartridge section comprises a liquid reservoir chamber, a liquid container, a container piercing element and a resilient container holding element, wherein the actuating cartridge section is configured to dock with the main cartridge section and comprises a first end and an actuating member, the first end is pivotably connected to the main cartridge section and the actuating member is configured to interact with the liquid container during docking;
the liquid container, the piercing element and the container holding element are arranged in the liquid reservoir chamber, the liquid container is filled with a suitable processing liquid and features a pierceable dispensing side, and the container piercing element faces the dispensing side;
the actuating cartridge section may be arranged in a non-docking position in which the liquid container is held in a first position by the container holding element, in the first position the dispensing side is separated from the container piercing element and the sample collector is available for collection of a sample; and the method comprises the steps of:
holding the actuating cartridge section in the non-docking position;
collecting a sample with the sample collector; and
pivoting the actuating cartridge section to a docked position, in which the actuating member has moved the liquid container from the first position to a second position wherein the dispensing side is pierced by the container piercing element.
